(19) United States
(12) Patent Application Publication
(10) Pub. No.: US 2017/0089555 A1
(43) Pub. Date: Mar. 30, 2017

(54) MOUNTING DEVICE TO PROVIDE LIGHTING FOR A DISPENSING APPARATUS

(71) Applicant: Harold Honeycutt, III, Kissimmee, FL (US)

(72) Inventor: Harold Honeycutt, III, Kissimmee, FL (US)

(21) Appl. No.: 15/275,792

(22) Filed: Sep. 26, 2016

Related U.S. Application Data
(60) Provisional application No. 62/222,847, filed on Sep. 24, 2015.

(51) Int. Cl. F21V 21/088; A01M 7/00; F21V 21/14; B05B 15/00; F21L 4/02; F21V 23/04

(52) U.S. Cl. CPC F21V 21/0885; F21L 4/02; F21V 23/0414; F21V 21/14; B05B 15/00; A01M 7/0046; F21Y 2115/10

(57) ABSTRACT

Disclosed is a mounting device configured to provide lighting for a dispensing apparatus. The mounting device includes an apparatus connection mechanism configured to detachably attach the mounting device to a dispensing apparatus. Additionally, the mounting device includes a light fastener configured to detachably attach the mounting device to a light source. Also disclosed is a method of manufacturing a mounting device configured to provide lighting for a dispensing apparatus. The method includes forming an apparatus connection mechanism configured to detachably attach the mounting device to a dispensing apparatus. Further, the method includes forming a light fastener configured to detachably attach the mounting device to a light source.

### CROSS-REFERENCE TO RELATED APPLICATIONS

This application claims priority from a provisional patent application No. 62/222,847, filed on Sep. 24, 2015, titled “LED Bait Gun for Pest Control Industries” which is incorporated herein by reference in its entirety.

### FIELD OF THE DISCLOSURE

Generally, the disclosure relates to dispensing apparatus. More specifically, the disclosure relates to a mounting device to provide lighting for a dispensing apparatus.

### BACKGROUND

Dispensing apparatuses are commonly used to facilitate the task of accurately dispensing a controlled quantity of substance, such as a liquid, gas or a paste, to an area of interest. The dispensing apparatus is generally made up of a dispensing nozzle, a storage chamber, and a pressure-inducing mechanism which enables the dispensing of the substance in the storage chamber. It has major applications in automotive industries where tasks like oiling, greasing, and coating of small automotive parts need to be carried out with utmost precision. Further, such dispensing apparatus have proven beneficial in the medical domain as well, where a patient is given a supply of liquid food through a dispensing apparatus.

Further, dispensing apparatuses are also used for pest control at various locations, such as but not limited, houses, workshops, fields, hospitals, etc. Such a dispensing apparatus is specifically configured to dispense a pesticide or other pest-control substance over the desired region with greater reach and effectiveness. Most of these dispensing apparatuses are provided as handheld units which helps a person to reach corners and crevices while exercising greater control in dispensing the pest-control substance.

However, despite the adaptive and compact designs, existing dispensing apparatuses suffer drawbacks in certain situations where there is a need to accurately dispense a substance in a region fraught with obstructed views, peculiar angles of access, or small volumes. Accordingly, in such cases, it is required to provide sufficient illumination to the region where the substance is to be dispensed so that an operator may accurately dispense the substance in the required quantity.

Typically, in such situations an operator uses a flashlight in one hand while holding the dispensing apparatus in the other hand. However, this is inconvenient and places a burden on the operator. Further, while helmet-mounted flashlights do free the operator from holding the flashlight, it's very difficult for the operator to orient the flashlight in line with an outlet of the dispensing apparatus.

Therefore, there is a need for improved methods, apparatus and devices to provide lighting for dispensing apparatus.

### SUMMARY

Disclosed is a mounting device configured to provide lighting for a dispensing apparatus. The mounting device comprises an apparatus connection mechanism configured to detachably attach the mounting device to a dispensing apparatus. Additionally, the mounting device comprises a light fastener configured to detachably attach the mounting device to a light source.

Further disclosed is a method of manufacturing a mounting device configured to provide lighting for a dispensing apparatus. The method comprises forming an apparatus connection mechanism configured to detachably attach the mounting device to a dispensing apparatus. Further, the method comprises forming a light fastener configured to detachably attach the mounting device to a light source.

### BRIEF DESCRIPTION OF DRAWINGS

FIG. 1A illustrates a schematic diagram showing a side-view of a dispensing apparatus, in accordance with an embodiment.

FIG. 1B illustrates a schematic diagram showing a top-view of the dispensing apparatus, in accordance with an embodiment.

FIG. 2 illustrates an isometric perspective view of a mounting device detachably attached to a light source, in accordance with an embodiment.

FIG. 3A-3B illustrates a schematic diagram showing a top-view and a bottom-view of the mounting device detachably attached to the light source, in accordance with an embodiment.

FIG. 4 illustrates a perspective view of the light source, in accordance with an embodiment.

FIG. 5A illustrates a schematic diagram showing a side-view of the dispensing apparatus detachably attached to the mounting device which in turn is detachably attached to the light source, in accordance with an embodiment.

FIG. 5B illustrates a schematic diagram showing a top-view of the dispensing apparatus detachably attached to the mounting device which in turn is detachably attached to the light source, in accordance with an embodiment.

FIG. 6 illustrates a flowchart of a method of manufacturing the mounting device, in accordance with an embodiment.

FIG. 7 illustrates a perspective view of the mounting device (a C-shaped clip), in accordance with an embodiment.

FIG. 8A-8B illustrates a schematic diagram showing a front-view and a rear-view of the mounting device detachably attached to the light source, in accordance with an embodiment.

FIG. 9A-9B illustrates a schematic diagram showing a left-side view and a right-side of the mounting device detachably attached to the light source, in accordance with an embodiment.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary.

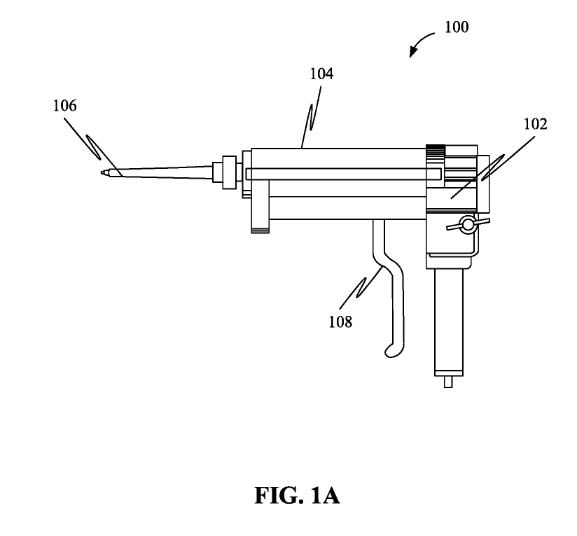

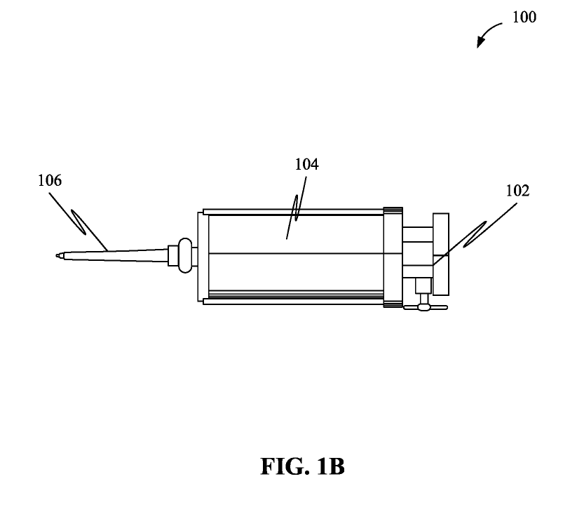

FIG. 1A illustrates a schematic diagram showing a side-view of a dispensing apparatus, in accordance with an embodiment. The dispensing apparatus 100 may be configured to dispense one or more substance in a controlled manner. The one or more substances may include, but are not limited to, one or more of a pest bait, an insecticide, a rodenticide and an avicide.

Accordingly, the dispensing apparatus 100 includes each of a dispenser housing 102, a removable cartridge 104, a nozzle 106, and a trigger 108. The dispenser housing 104 may correspond to one or more of two or more of shapes and two or more of sizes. In other words, the dispenser housing 102 may assume a variety of shapes and sizes depending on requirements.

Further, the removable cartridge 104 includes one or more substance to be dispensed. The removable cartridge 104 may be detachably attached with the dispensing apparatus 100. Further, the removable cartridge 104 may correspond to one or more of two or more of shapes and two or more of sizes. In other words, the removable cartridge 104 may assume a variety of shapes and sizes depending on the design of the dispensing apparatus 100. For example, the removable cartridge 104 may be cylindrical in shape with a specific diameter.

Further, the dispenser housing 102 may include a pump to dispense the one or more substances under a required pressure through the nozzle 106. The dispenser housing 102 may include a movable wall configured to cooperate with the removable cartridge 104 to expel the one or more substances through the nozzle 106. The trigger 108 may be configured to exert pressure on the movable wall such that the one or more substances may be dispensed in a controlled quantity. In some embodiments, the dispensing apparatus 100 may be configured to be hand-held. Further, in another embodiment the dispensing apparatus 100 may include a gun, such as for example, a pest bait gun. FIG. 1B illustrates a schematic diagram showing a top-view of the dispensing apparatus, in accordance with an embodiment.

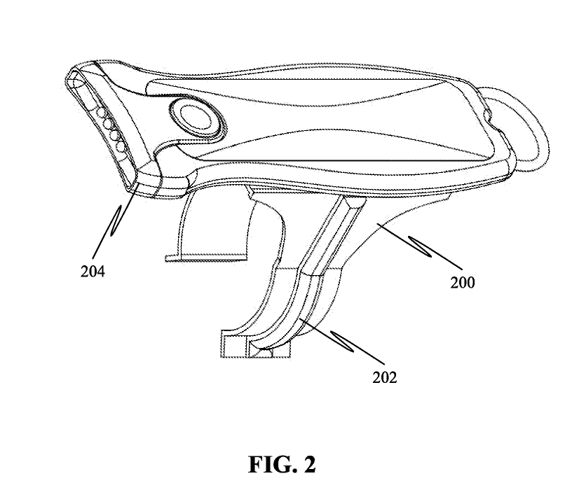

FIG. 2 illustrates an isometric perspective view of a mounting device detachably attached to a light source, in accordance with an embodiment. The mounting device 200 may be configured to provide lighting for the dispensing apparatus 100. The mounting device 200 may include an apparatus connection mechanism 202 configured to detachably attach the mounting device 200 to the dispensing apparatus 100. Additionally, the mounting device 200 may include a light fastener configured to detachably attach the mounting device 200 to a light source 204. Further, the mounting device 200 may be such that when attached only to the light source 204, the mounting device 200 along with the light source 204 may function as a handheld light source with better holding grip. Accordingly, in some embodiments, the mounting device 200 may serve a dual purpose as, for example, a bait gun attachment mechanism and a standalone flashlight.

The light source 204 may include each of a battery, one or more light emitting diode (LED) and a power switch. Additionally, the LEDs may provide a light beam of sufficient intensity to illuminate dark and cramped spaces where the one or more substances, such as for example, pest control bait is to be dispersed.

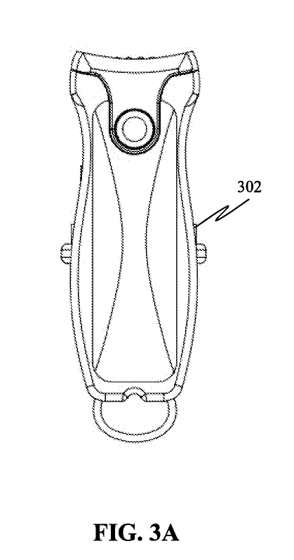

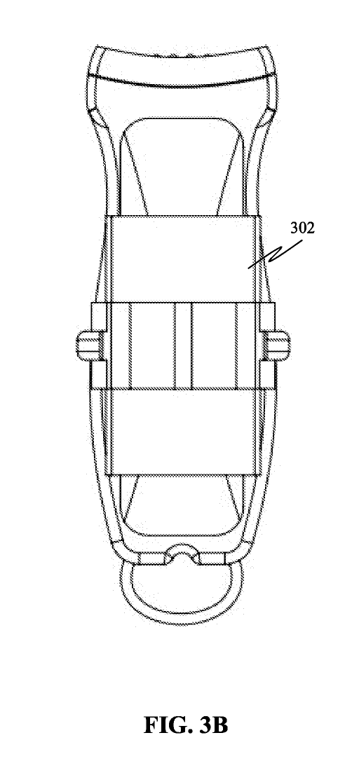

FIG. 3A-3B illustrates a schematic diagram showing a top-view and a bottom-view of the mounting device 200 detachably attached to the light source 204, in accordance with an embodiment. The mounting device 200 may include the light fastener 302 such as, but not limited to, one or more of a Velcro fastener, a clip fastener, a latch fastener, a button fastener and a clamp fastener.

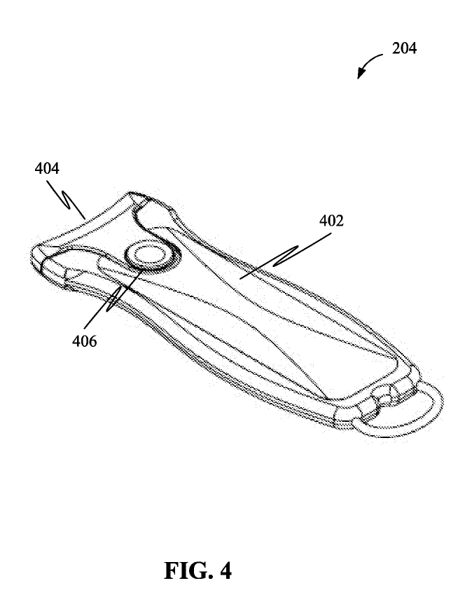

Further, in FIG. 4 a perspective view of the light source 204, in accordance with an embodiment is illustrated. The light source may include each of the battery 402, the one or more light emitting diode (LED) 404, and the power switch 406.

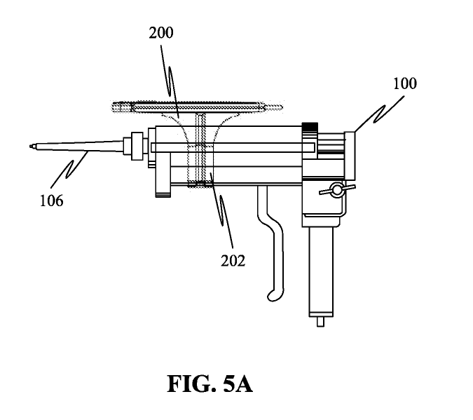

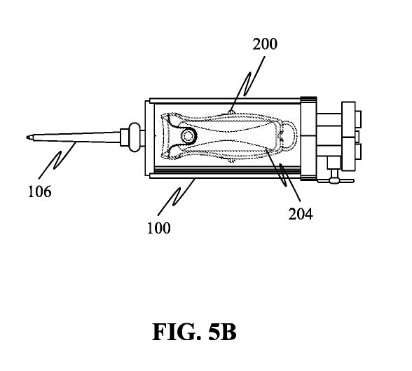

FIG. 5A illustrates a schematic diagram showing a side-view of the dispensing apparatus 100 detachably attached to the mounting device 200 which in turn is detachably attached to the light source 204, in accordance with an embodiment. The apparatus connection mechanism 202 may be configured to detachably attach the mounting device 200 to one or more of the dispenser housing 102 and the removable cartridge 104. In some embodiments, the apparatus connection mechanism 202 may be configured to detachably attach the mounting device 200 to the dispensing apparatus 100 near an outlet, such as for example nozzle 106, of the dispensing apparatus 100.

Further, FIG. 5B illustrates a schematic diagram showing a top-view of the dispensing apparatus 100 detachably attached to the mounting device 200 which in turn is detachably attached to the light source 204, in accordance with an embodiment. Further, the light fastener 302 may be configured to enable the light source 204 to be mounted at one of two or more orientations with respect to the dispensing apparatus 100. Accordingly, the light source 204 may be attached to the mounting device 200 to illuminate a region where the one or more substance is dispensed. For instance, a direction of light beam from the light source 204 may be in-line with the nozzle 106.

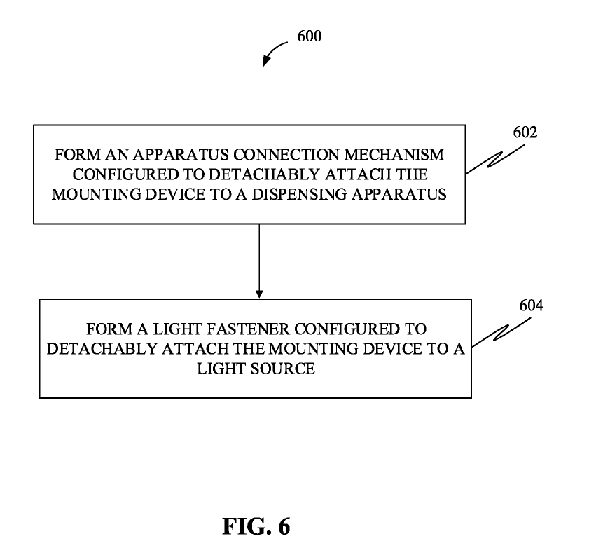

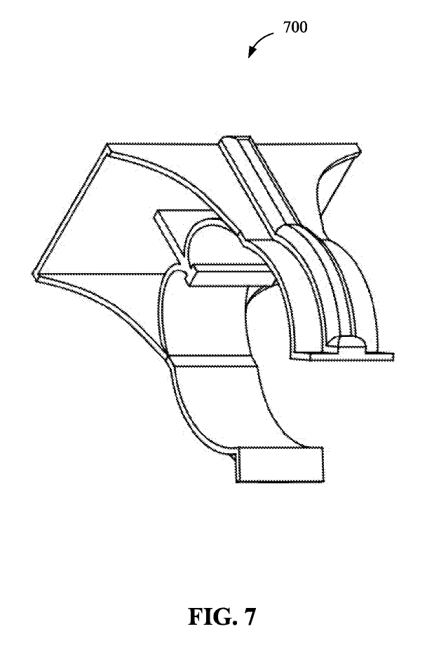

FIG. 6 illustrates a flowchart of a method of manufacturing the mounting device 200, in accordance with an embodiment. At step 602, the method may include forming the apparatus connection mechanism 202 configured to detachably attach the mounting device 200 to the dispensing apparatus 100. Further, the forming may be such that the apparatus connection mechanism 202 may be configured to be adjustable based on one or more of a shape of the two or more of shapes and a size of the two or more of sizes. For instance, the apparatus connection mechanism 202 may include one or more of a C-shaped clip and an adjustable strap. FIG. 7 illustrates a perspective view of the mounting device 200 in the form of the C-shaped clip 700, in accordance with an embodiment. The C-shaped clip 700 may be configured to clamp around an exterior surface of the dispensing apparatus 100, such as for example, around the exterior of the removable cartridge 104.

Again referring to FIG. 6, at step 604, the method may include forming the light fastener 302 configured to detachably attach the mounting device 200 to the light source 204. Further, the light fastener 302 may include one or more of a Velcro fastener, a clip fastener, a latch fastener, a button fastener and a clamp fastener. Further, the light fastener 302 may be configured to be adjustable based on one or more of a shape of two or more of shapes and a size of two or more of sizes corresponding to the light source 204. The Velcro fastener (not shown in FIG. 6) may include one or more strips (e.g. loop portion) which may be configured to be attached to the dispensing apparatus 100. Further, one or more complementary strips of the Velcro fastener (e.g. hook portion) may be configured to be attached to the mounting device 200. Additionally, the Velcro fastener may be configured to perform an interlocking between a strip hooks and a complementary strip including loops. In some embodiments, the interlocking may be performed to detachably mount the mounting device 200 to the dispensing apparatus 100.

The forming in each step 602 and 604 may be performed using one or more manufacturing methods such as, but not limited to, die molding, injection molding, milling, stamping, etching, engraving, gluing and so on. Further, one or more suitable materials such as, but not limited to, metals, alloys and plastics may be used in forming the mounting device 200.

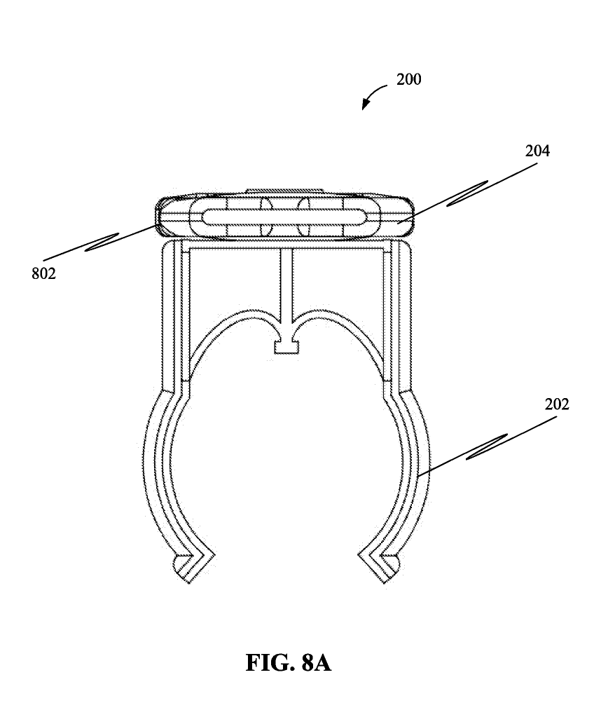

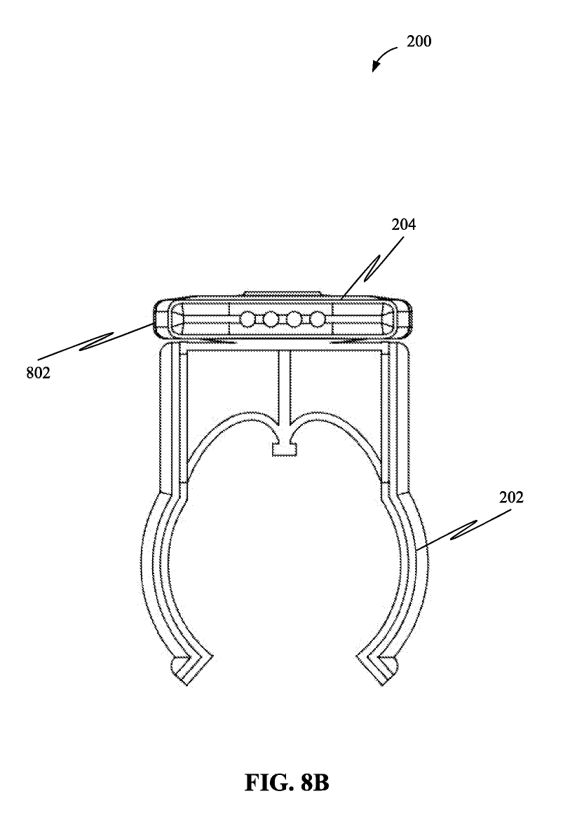

FIG. 8A-8B illustrate a schematic diagram showing a front-view and a rear-view of the mounting device 200 detachably attached to the light source 204, in accordance with an embodiment. In an instance, the light source 204 may include one or more light emitting diodes (LED) 404. In some embodiments, the light fastener 302 may include a ball-socket joint (not shown in figures). The ball-socket joint may further be configured to enable the light source 204 to be oriented in one of two or more of orientations.

Further, the light source 204 may include a housing 802. Accordingly, the light fastener 302 may be configured to detachably attach the mounting device 200 to the housing 802. Further, the light fastener 302 may be configured to detachably attach the mounting device to the housing 802 corresponding to one or more of two or more of shapes and two or more of sizes. In other words, the light fastener 302 may be adjusted to mount the light source 204 assuming a variety of forms and sizes.

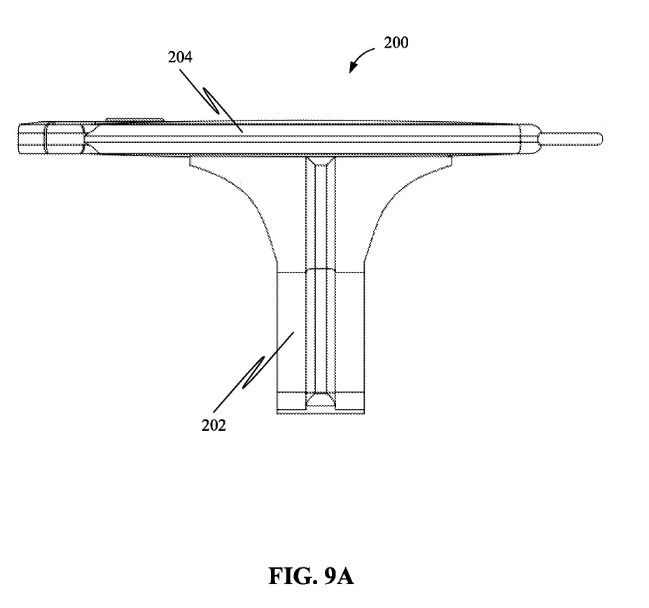

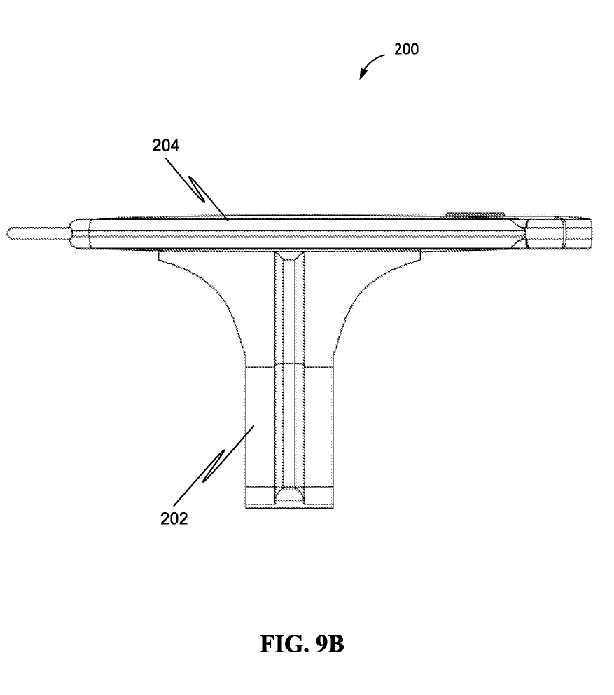

Additionally, FIG. 9A-9B illustrates a schematic diagram showing a left-side view and a right-side of the mounting device 200 detachably attached to the light source, in accordance with an embodiment. In some embodiment, the mounting device 200 may include latch fastener (not shown in figures) to detachably attach the light source 204 to the apparatus connection mechanism 202. Further, the latch fastener may be configured to detachably attach the apparatus connection mechanism 202 to the dispensing apparatus 100.

Although the invention has been explained in relation to its preferred embodiment, it is to be understood that many other possible modifications and variations can be made without departing from the spirit and scope of the invention.

We claim:

1. A mounting device configured to provide lighting for a dispensing apparatus, wherein the mounting device comprises:
an apparatus connection mechanism configured to detachably attach the mounting device to a dispensing apparatus; and
a light fastener configured to detachably attach the mounting device to a light source.

2. The mounting device of claim 1, wherein the dispensing apparatus is configured to be hand-held.

3. The mounting device of claim 1, wherein the dispensing apparatus comprises a gun.

4. The mounting device of claim 1, wherein the dispensing apparatus is configured to dispense at least one substance.

5. The mounting device of claim 4, wherein the at least one substance comprises a pest bait.

6. The mounting device of claim 4, wherein the at least one substance comprises at least one of an insecticide, a rodenticide and an avicide.

7. The mounting device of claim 1, wherein at least one of the apparatus connection mechanism and the light fastener is configured to enable the light source to be mounted at one of a plurality of orientations with respect to the dispensing apparatus.

8. The mounting device of claim 7, wherein at least one of the apparatus connection mechanism and the light fastener comprises a ball-socket joint configured to enable the light source to be oriented in one of the plurality of orientations.

9. The mounting device of claim 4, wherein the apparatus connection mechanism is configured to detachably attach the mounting device to the dispensing apparatus near an outlet of the dispensing apparatus, wherein the light source attached to the mounting device illuminates a region where the at least one substance is dispensed.

10. The mounting device of claim 1, wherein the apparatus connection mechanism comprises at least one of a C-shaped clip and an adjustable strap, wherein the C-shaped clip is configured to clamp around an exterior surface of the dispensing apparatus.

11. The mounting device of claim 1, wherein the light fastener comprises at least one of a Velcro fastener, a clip fastener, a latch fastener, a button fastener and a clamp fastener.

12. The mounting device of claim 1, wherein the light source comprises each of a battery, at least one light emitting diode (LED) and a power switch.

13. The mounting device of claim 1, wherein the light source comprises a housing, wherein the light fastener is configured to detachably attach the mounting device to the housing.

14. The mounting device of claim 13, wherein the light fastener is configured to detachably attach the mounting device to the housing corresponding to at least one of a plurality of shapes and a plurality of sizes.

15. The mounting device of claim 14, wherein the light fastener is configured to be adjustable based on at least one of a shape of the plurality of shapes and a size of the plurality of sizes.

16. The mounting device of claim 1, wherein the dispensing apparatus comprises each of a dispenser housing and a removable cartridge, wherein the removable cartridge comprises at least one substance to be dispensed, wherein the apparatus connection mechanism is configured to be detachably attach the mounting device to at least one of the dispenser housing and the removable cartridge.

17. The mounting device of claim 16, wherein the dispenser housing corresponds to at least one of a plurality of shapes and a plurality of sizes.

18. The mounting device of claim 16, wherein the removable cartridge corresponds to at least one of a plurality of shapes and a plurality of sizes.

19. The mounting device of claim 18, wherein the apparatus connection mechanism is configured to be adjustable based on at least one of a shape of the plurality of shapes and a size of the plurality of sizes.
